(19) United States
(12) Patent Application Publication
(10) Pub. No.: US 2004/0081170 A1
(43) Pub. Date: Apr. 29, 2004

(54) Method and device for the activation of an information communication function by a remote device

(75) Inventor: Stephane Schinazi, Latresne (FR)

Correspondence Address: IP DEPARTMENT OF PIPER RUDNICK LLP, 3400 TWO LOGAN SQUARE, 18TH AND ARCH STREETS, PHILADELPHIA, PA, 19103, US

(73) Assignee: E-DEVICE INC., a corporation of New York, Brooklyn, NY

(21) Appl. No.: 10/634,486

(22) Filed: Aug. 5, 2003

Related U.S. Application Data
(63) Continuation of application No. PCT/FR02/00442, filed on Feb. 5, 2002.

(30) Foreign Application Priority Data
Feb. 5, 2001 (FR) 01/01580

(51) Int. Cl. H04L 12/56

(52) U.S. Cl. 370/395.52

(57) ABSTRACT

A method of activating an information communication function by a remote device that can be connected to the Internet and to a telecommunication network including activating the remote device by a local or remote event; connecting the remote device to an Internet access provider in response to the activation; reading a temporary IP address assigned by the access provider during the connection step, and either a) transmitting the temporary IP address to an Internet terminal or a data processing system, and reading WEB pages stored locally by the remote device by the Internet terminal or by the data processing system, or b) directly transmitting data by outgoing and/or incoming electronic mail between the remote device and an Internet terminal or a data processing system without prior transmission of the temporary IP address.

### RELATED APPLICATION

This is a continuation of International Application No. PCT/FR02/00442, with an international filing date of Feb. 5, 2002, which is based on French Patent Application No. 01/01580, filed Feb. 5, 2001.

### FIELD OF THE INVENTION

This invention pertains to a device that can be activated by a remote means for the transmission of information via the Internet.

### BACKGROUND

Known in the state of the art is U.S. Pat. No. 6,094,477, which describes a terminal connected to a telephone network via an interface and comprising an acquisition unit for analysis of the call signal and establishment of a connection as a function of said analysis.

WO 00/13403 pertains to a system and a method intended to implement a telephone call in relation to a network such as the Internet in a manner to provide registration and presentation of an invoice in real time. The system comprises a Web server, a client computer, an enterprise database and a communication switch. The method comprises the following stages: electronic registration with a supplier of electronic services via the network, assignment to the client of a unique call establishment telephone number, call establishment, calculation of the price of the telephone call and presentation to the client of the information regarding the price in real time. Activation of the network allows the client to subscribe to a call and implement it immediately after registration. The information regarding the price can be personalized as a function of the client by using price tables associated with different components of the overall price (telephone fee) of the telephone call.

WO 00/00908 pertains to a server enabling access on demand to web pages stored remotely and independently of a web page service provider. The provider of web page services provides an index containing a reference to more detailed web pages. The more detailed web pages are stored locally with the third party providing the web pages, e.g., on a computer located on the client's facility. When a user of the web page service opens a request for a more detailed web page, the web page service telephones the computer located on the client's facility, down-loads the requested web page and provides it to the user. The index can be based on geographic data, thus providing access to the web pages on the basis of the parameter client and user location.

WO 99/27697 pertains to a device and method for verifying whether a client is authorized to use a telephony gateway offered by a telephony gateway service provider. The client activates a link comprising the telephone number of a subscriber B on a Web page of a Web server; a verification function ascertains whether the client is authorized to use the telephony gateway; and a telephone call is established with the gateway as a function of said verification.

It would therefore be advantageous to enable remote transmission of data in the preferential form of a web page, an e-mail message or an FTP transfer by activation by an event such as a clock or an incoming call. It would also be advantageous to have applications pertaining to the remote collection of data from meters, vending machines or control and surveillance devices not having available a permanent IP address.

### SUMMARY OF THE INVENTION

This invention relates to a method of activating an information communication function by a remote device that can be connected to the Internet and to a telecommunication network including activating the remote device by a local or remote event, connecting the remote device to an Internet access provider in response to the activation, reading a temporary IP address assigned by the access provider during the connection step and either transmitting the temporary IP address to an Internet terminal or a data processing system, and reading WEB pages stored locally by the remote device by the Internet terminal or by the data processing system, or directly transmitting data by outgoing and/or incoming electronic mail between the remote device and an Internet terminal or a data processing system without prior transmission of the temporary IP address.

### BRIEF DESCRIPTION OF THE DRAWINGS

Better understanding of the present invention will be acquired by reading the description below of a nonlimitative example of implementation with reference to the attached drawing in which:

FIG. 1 is a flow chart manifesting aspects of the invention.

### DETAILED DESCRIPTION

The invention pertains to a method for activating an information communication function by a remote device such as, for example, an electric meter or water meter, a vending machine or a programmable automated dispensing machine that can be connected to the Internet and to a telecommunication network via a telephone line or via a wireless telephone network such as the GSM network. The remote device comprises means for implementing Internet protocols, signal processing means for the effective transmission of physical signals on the telecommunication network and an interface with the telecommunication network capable of detecting an incoming call. The method comprises a step of activation of the remote device by a local or remote event, e.g., a telephone call or a time delay and the connection to the Internet access provider in response to the activation step, characterized in that the method comprises a step of reading a temporary IP address assigned by the access provider during the connection step and either a step of transmission of the temporary IP address to an Internet terminal or a data processing system, followed by a step of reading WEB pages stored locally by the remote device by the Internet terminal or by the data processing system, or a step of direct transmission of data by electronic mail (outgoing and/or incoming) between the remote device and an Internet terminal or a data processing system without prior transmission of the temporary IP address.

The method advantageously comprises an initial step of verification of the incoming call by the remote device.

According to a variant, the step of verification of the incoming call by the remote device consists of ascertaining whether the identifier of the incoming call, e.g., the Caller ID or the telephone number corresponds to a pre-registered identifier.

According to a particular mode of implementation, the event triggering the connection to the access provider is a clock.

The device preferably comprises a Web page server for preparing a page comprising at least a pre-registered part and at least a part containing a variable updated by a measurement means associated with the device.

According to a preferred mode of implementation, the device comprises an Internet integrated monolithic electronic component comprising an architecture of the DSP type (Digital Signal Processor) for connection to a telecommunication network and data exchange according to at least a part of the protocols.

The invention also pertains to a device comprising a means for access to the Internet and implementation of Internet protocols, a means for access to a telecommunication network via a telephone line or via a wireless telephone network such as the GSM network, and an interface with the telecommunication network capable of detecting an incoming call, as well as a means for detection of an incoming call and activation of the connection to an Internet access provider as well as, optionally, a memory for registration of the temporary IP address assigned by the access provider during the connection step, and transmission of the temporary IP address to a remote Internet terminal or to a data processing system.

The device preferably comprises a memory for registering components of at least one web page.

According to a variant, it comprises a means for creating a web page comprising components recorded in random-access memory and components stemming from a data acquisition means associated or integrated with the device.

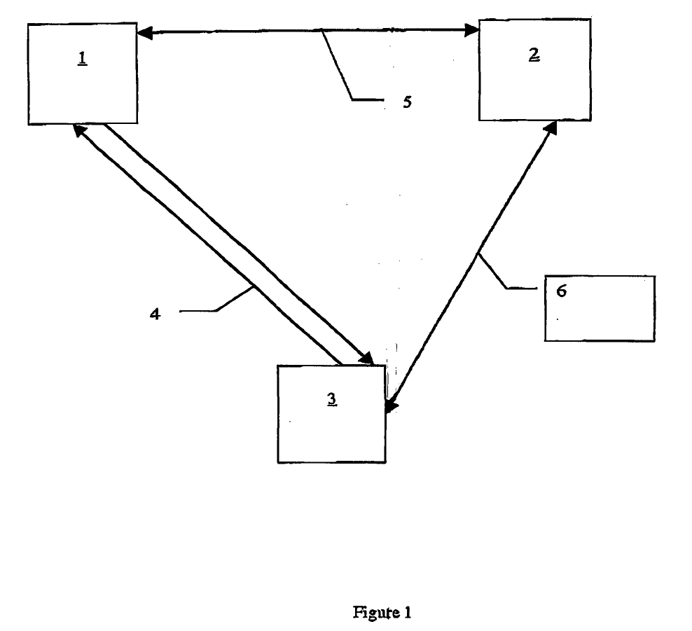

Turning now to the Drawing, FIG. 1 shows the flow of data among the different devices: a remote device (1), an Internet access provider server (2), and a control station (3). The remote device (1) is a device comprising an interface for access to both a telephone network and the Internet. The means for accessing these two networks are not described in detail in the framework of the invention because they are known in the art.

The remote device (1) can be an electric or gas meter that can be accessed remotely, a vending machine or programmable automated dispensing machine or any metering device requiring remote verification or recovery of information. Such a device is advantageously equipped with an integrated monolithic electronic component for connection to a telecommunication network and data exchange in accordance with at least part of the Internet protocols comprising an architecture of the DSP type (Digital Signal Processor). The component according to the invention preferably also comprises an analogue/digital conversion component for the link with a telecommunication network. This component is, for example, a DSP component comprising modem functions in which is also loaded a program for the execution of reduced Internet protocols.

This is a component comprising an integrated processor for processing the digital signal and for producing intermediary data and a RAM (random-access memory) group partitioned to store in memory the intermediary digital data.

The modem program controls the connection to the physical network linking the device to the Internet access point (2). The program for executing the Internet protocols processes both the low layers (PPP, IP, TCP) and the high layers (HTTP, SMTP, POP3, FTP) of the set of Internet protocols.

The programs loaded in the DSP thus contain multiple protocols, including but not limited to the following: PPP, IP, TCP, a part of HTTP for controlling a simple web server, SMTP for sending e-mail messages, POP3 for receiving messages, FTP for downloading files, and Telnet.

The data are processed according to a particular algorithm avoiding the use of a multiplicity of storage memories to enable execution of these programs in the low-capacity memories of the DSP.

The device does not have a permanent IP address. It is activated by an incoming call generated by the control station (3) (arrow 4).

The device (1) verifies the incoming call, e.g., by means of the Caller ID or any other information available in the call signal for ascertaining whether the caller has access rights.

In the case of a positive verification, the device opens a session by connecting to the server (2) of the access provider (arrow 5).

The access provider assigns a temporary IP address which is transmitted to the remote device (1).

Two operating scenarios are then possible:

in the first scenario, this information is communicated to the control station (3) by the telephonic link and the Internet (arrows 5 and 6). The control station (3) can then access the web page server of the device (1) via the access provider (2) to access the web page recorded in the remote device (1), comprising fixed data and variable data.

in the second scenario, the data are transmitted directly by e-mail (incoming and/or outgoing) between the device (1) and the control station (3) via the telephonic link and the Internet (arrows 5 and 6).

1. A method for the activation of an information communication function by a remote device that can be connected to the Internet and to a telecommunication network, said device comprising means for implementing Internet protocols, signal processing means for the effective transmission of physical signals on the telecommunication network and an interface with the telecommunication network capable of detecting an incoming call, the method comprising a step of activation of said connectable device by a local or remote event and the connection to the Internet access provider in response to said activation step, characterized in that the method comprises a step of reading a temporary IP address assigned by the access provider during the connection step and:
either a step of transmission of said temporary IP address to an Internet terminal or a data processing system, followed by a step of reading WEB pages stored locally by said remote device by said Internet terminal or by said data processing system,
or a step of direct transmission of data by electronic mail between said remote device and an Internet terminal or a data processing system without prior transmission of the temporary IP address.

2. The method for the activation of an information communication function according to claim 1, characterized in that it comprises an initial step of verification of the incoming call by the remote device.

3. The method for the activation of an information communication function according to claim 1, characterized in that said step of verification of the incoming call by the remote device consists of ascertaining whether the identifier of the incoming call corresponds to a pre-registered identifier.

4. The method for the activation of an information communication function according to claim 1, characterized in that the event triggering the connection to the access provider is a clock.

5. The method for the activation of an information communication function according to claim 1, characterized in that the device comprises a Web page server for the preparation of a page comprising at least a pre-registered part and at least a part containing a variable updated by a measurement means associated with said device.

6. The method for the activation of an information communication function according to claim 1, characterized in that the device comprises an Internet integrated monolithic electronic component comprising an architecture of the DSP type (Digital Signal Processor) for connection to a telecommunication network and data exchange according to at least a part of the Internet protocols.

7. A device for the activation of an information communication function in accordance with the method according to claim 1, characterized in that it comprises a means for access to the Internet and implementation of Internet protocols, a means for access to a telecommunication network, and an interface with the telecommunication network capable of detecting an incoming call, as well as a means for detection of an incoming call and activation of the connection to an Internet access provider as well as a memory for registration of the temporary IP address assigned by the access provider during the connection step, and transmission of said temporary IP address to a remote Internet terminal or to a data processing system.

8. The device for the activation of an information communication device according to claim 7, characterized in that it comprises a memory for registering components of at least one web page.

9. The device for the activation of an information communication device according to claim 7, characterized in that it comprises a means for the creation of a web page comprising components recorded in random-access memory and components stemming from a data acquisition means associated or integrated with the device.

10. The device for the activation of an information communication device according to any one of claims 7 to 9, characterized in that it has an Internet integrated monolithic electronic component comprising an architecture of the DSP type (Digital Signal Processor) for connection to a telecommunication network and data exchange in accordance with at least part of the Internet protocols.

11. A method of activating an information communication function by a remote device that can be connected to the Internet and to a telecommunication network comprising:
activating the remote device by a local or remote event;
connecting the remote device to an Internet access provider in response to the activation;
reading a temporary IP address assigned by the access provider during the connection step, and
either a) transmitting the temporary IP address to an Internet terminal or a data processing system, and reading WEB pages stored locally by the remote device by the Internet terminal or by the data processing system, or
b) directly transmitting data by outgoing and/or incoming electronic mail between the remote device and an Internet terminal or a data processing system without prior transmission of the temporary IP address.

12. The method according to claim 11, wherein the remote device is selected from the group consisting of an electric meter, a water meter, a vending machine and a programmable automated dispensing machine.

13. The method according to claim 11, further comprising an initial step of verification of the incoming call by the remote device.

14. The method according to claim 13, wherein the step of verification of the incoming call by the remote device comprises ascertaining whether an identifier of the incoming call (e.g., the Caller ID or the telephone number) corresponds to a pre-registered identifier.

15. The method according to claim 14, wherein the identifier of the incoming call is a Caller ID or a telephone number.

16. The method according to claim 11, wherein the event triggering the connection to the access provider is a clock.

17. The method according to claim 11, wherein the remote device comprises a Web apge server for preparing a page comprising a least a pre-registered part and at least a part containing a variable updated by a measurement means associated with the remote.

18. The method according to claim 11, wherein the remote device comprises an Internet integrated monolithic electronic component comprising an architecture of the DSP type (Digital Signal Processor) for connection to the telecommunication network and data exchange according to at least a part of the Internet protocols.

19. The method according to claim 11, wherein the remote device comprises:
means for access to the Internet and implementation of Internet protocols;
means for access to the telecommunication network;
an interface with the telecommunication network capable of detecting an incoming call;
means for detection of an incoming call and activation of a connection to the Internet access provider; and
a memory for registration of the temporary IP address and transmission of the temporary IP address to a remote Internet terminal or to a data processing system.

20. The method according to claim 19, wherein the remote device further comprises a memory for registering components of at least one web page.

21. The method according to claim 19, wherein the remote device further comprises means for creating a web page comprising components recorded in random-access memory and components stemming from a data acquisition means associated or integrated with the remote device.

22. The method according to claim 20, wherein the remote device further comprises an Internet integrated monolithic electronic component comprising an architecture of the DSP type (Digital Signal Processor) for connection to the telecommunication network and data exchange in accordance with at least part of the Internet protocols.
